(19) United States
(12) Patent Application Publication
(10) Pub. No.: US 2012/0016558 A1
(43) Pub. Date: Jan. 19, 2012

(54) ANTITHEFT DEVICE FOR VEHICLE

(76) Inventors: Koki Ueno, Aichi (JP); Atsushi Kamada, Aichi (JP); Takahiko Tsutsumi, Aichi (JP)

(21) Appl. No.: 13/256,299

(22) PCT Filed: Mar. 3, 2010
(86) PCT No.: PCT/JP2010/053932

§ 371 Date: Sep. 13, 2011

(30) Foreign Application Priority Data
Mar. 23, 2009 (JP) 2009-070374

(51) Int. Cl. B60R 25/06

(52) U.S. Cl. 701/51

(57) ABSTRACT

An antitheft device for vehicle includes store means storing a parking-lock canceling state activating a parking lock canceling operation and a parking lock state disabling the parking lock canceling operation alternatively, and switching means switching the parking lock state to the parking-lock canceling state upon success of a verification, an initial value of the store means being set to the parking-lock canceling state.

### FIELD OF THE INVENTION

The present invention relates to an antitheft device installed on a vehicle and, more particularly, to a setting of the antitheft device for a vehicle assembly.

### DESCRIPTION OF THE RELATED ART

An antitheft device for vehicle has heretofore been known as including store means for storing a parking-lock canceling state activating a parking lock canceling operation, and a parking lock state disabling the parking lock canceling operation, and switching means for switching the parking lock state to the parking-lock canceling state upon success in verification. An antitheft device for vehicle disclosed in for instance Patent Publication 1 represents such an example.

Patent Publication 1 (JP2005-238884A) discloses a technology in which if a mismatch occurs between authentication results of authenticating means, the parking lock canceling operation is disabled to cause the parking lock state to be fixed, whereas if the authenticating means has a matching result, the parking lock canceling operation is activated to cause parking lock to be cancelled.

### DISCLOSURE OF THE INVENTION

During assembly of the vehicle equipped with the antitheft device, meanwhile, a verification and registration work is carried out after the vehicle has been assembled. If a failure occurs in the verification and registration work, the parking lock canceling operation is disabled to fix the vehicle under the parking lock state. With the vehicle fixed under such a parking lock state, an issue incapable of pushing the vehicle out of a production line arises. Such an issue will be described below with reference to FIG. 4.

FIG. 4 is a work view illustrating a process flow of the related art vehicle production line. Various steps in the process flow represent steps related to behaviors artificially carried out in essence. At a first step, initially, assembling work of the vehicle is carried out. Upon completion of work to assemble the vehicle, at a second step, an initial verification and registration work is carried out. As used herein, the term “verification and registration work” refers to an initial verification and registration work that is carried out at first, when making for instance a verification in code between a key (smart key) related to the assembled vehicle, and a verification ECU (Electronic Control Device) of the vehicle. Further, when a vehicle power supply is turned on when carrying out the verification and registration work, the vehicle is switched to the parking lock state.

At a third step, a determination is made as to whether verification and registration work carried out at the second step is completed in success. The third step is to determine whether the verification and registration work is completed within an operating time period determined for the production line. In addition, since the verification and registration work belongs to an artificial work, no verification and registration work is likely to be completed within the relevant operating time period due to some reasons. If the verification and registration work is completed within the relevant operating time period, the power supply is cut off or interrupted at fourth step (in IG-OFF). At a fifth step, the vehicle power supply is turned on again (in READY-ON). At a sixth step, further, operating a shift lever allows the parking lock state to be switched to the parking-lock canceling state (in P-lock cancellation), and at a seventh step, the vehicle is moved to a predetermined area, for instance, in free running.

On the contrary, if no verification and registration work is completed at the second step within the relevant operating time period, a determination is made at the third step that a failure occurs in the verification and registration work. In such a case, the relevant vehicle is pushed out of the production line once to carry out the verification and registration work is again in an area outside the production line so as not to halt the production line in operation. However, if the failure occurs in the verification and registration work at the second step, the parking lock canceling operation is disabled at a eighth step, and hence, no parking lock is cancelled. This makes it difficult to push the vehicle out of the production line by hand work or the like (disabling P-lock cancellation).

The present invention has been completed with the above view in mind, and has an object to provide in a vehicle equipped with an antitheft device an antitheft device for vehicle which can prevent the vehicle from fixing to a parking lock state where the vehicle is disabled from being pushed out of a production line when a failure occurs in a verification and registration work carried out during assembly.

For achieving the above object, a first aspect of the present invention provides an antitheft device for vehicle comprising store means storing a parking-lock canceling state activating a parking lock canceling operation and a parking lock state disabling the parking lock canceling operation alternatively or selectively, and switching means switching the parking lock state to the parking-lock canceling state upon success of a verification. An initial value of the store means is set to the parking-lock canceling state.

A second aspect of the present invention is featured by that the initial value of the store means is set to the parking-lock canceling state for assembly on a production line and is set to the parking lock state for assembly on other area than the production line.

According to the antitheft device for vehicle of the first aspect, the initial value of the store means is set to the parking-lock canceling state. Thus, even if a failure occurs in the verification and registration work carried out during assembly, the parking lock can be cancelled. Accordingly, canceling the parking lock can immediately push the vehicle out of the production line by hand work or the like. Associating with such an effect, a stop of the production line for push-out of the vehicle can be prevented.

According to the antitheft device for vehicle of the second aspect, the initial value of the store means is set to the parking-lock canceling state for assembly on a production line and is set to the parking lock state for assembly on other area than the production line. Accordingly, establishing the parking lock state in other area than the production line can prevent a drop in an antitheft performance when assembling the vehicle in the other area than the production line.

### BRIEF DESCRIPTION OF THE DRAWINGS

FIG. 1 is a view illustrating a structure of a parking lock mechanism installed in a vehicle, to which the present invention is applied.

FIG. 2 is a view schematically illustrating a system of an antitheft device.

FIG. 3 is a work view illustrating a working process of a vehicle production line applied in a present embodiment.

FIG. 4 is a work view illustrating a working process of a vehicle production line of a conventional art.

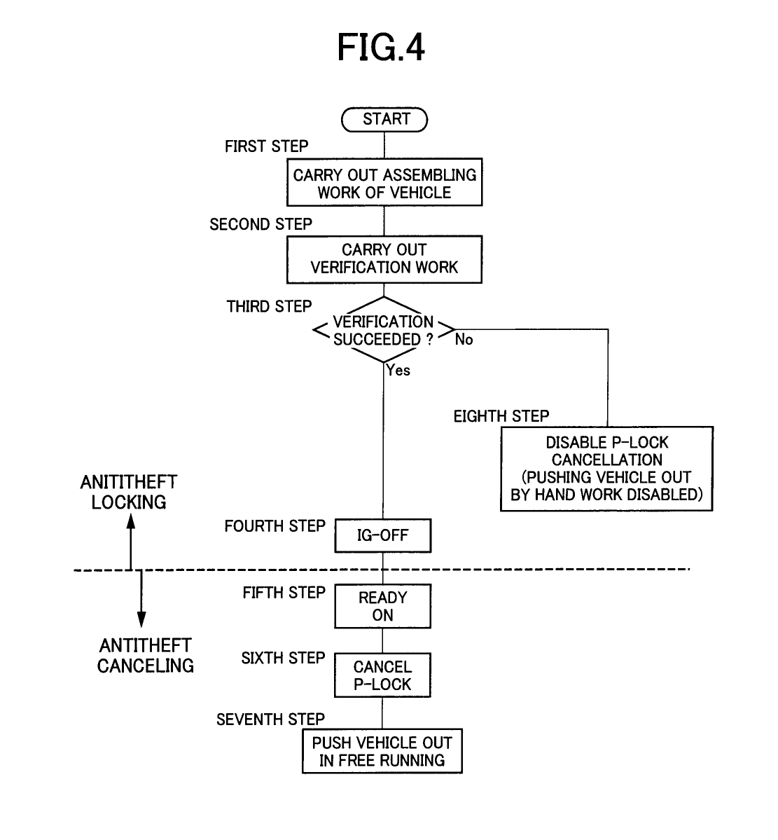

### DETAILED DESCRIPTION OF THE PREFERRED EMBODIMENTS

Preferably, the store means described above may be comprised of non-volatile memories (such as MRAM, EEPROM, EPROM and NVRAM, etc.,) that hold an information even if a power supply is cut off or interrupted. With such a structure, even if the power supply is cut off, the information can be held in the store means, i.e., memory means for causing the antitheft device to function effectively during a halt, i.e., stop of a vehicle. That is, if the store means is set to a parking lock state when the vehicle power supply is cut off, a parking-lock canceling operation is disabled for the halt of the vehicle, so that theft of the vehicle is prevented.

Further, preferably, the store means may be updated to a parking-lock canceling state to activate a parking-lock canceling operation upon a start-up of the vehicle. When the vehicle power supply is turned off, the store means is sequentially updated to a parking lock state to disable the parking-lock canceling operation. With such updating, the parking-lock canceling operation is activated for start-up of the vehicle, thereby making it possible to run the vehicle. Meanwhile, when the vehicle is halted with the vehicle power supply being turned off, the parking-lock canceling operation is disabled to prevent theft of the vehicle during the halt thereof.

Furthermore, preferably, the store information of the store means may precedes a shift command in response to a shift operation of a driver. With such priority, the parking lock state is sustained regardless of or independent of the shift operation of the driver, thereby preventing theft of the vehicle during the halt thereof During running of the vehicle, moreover, the parking-lock canceling state is established, so that the shift operation of the driver is permitted to enable the vehicle running.

Besides, preferably, the present invention may be applied to a shift-by-wire type vehicle such as for instance a hybrid vehicle and a vehicle including an automatic transmission, etc., which is configured to electrically switch running ranges of the vehicle via an electric actuator, etc.

Now, embodiments of the present invention will be described below in detail with reference to drawings. The embodiment described below is suitably simplified or modified in structure with none of various component parts being necessarily drawn accurately in dimension and shape or the like in accurate manners.

### Embodiment

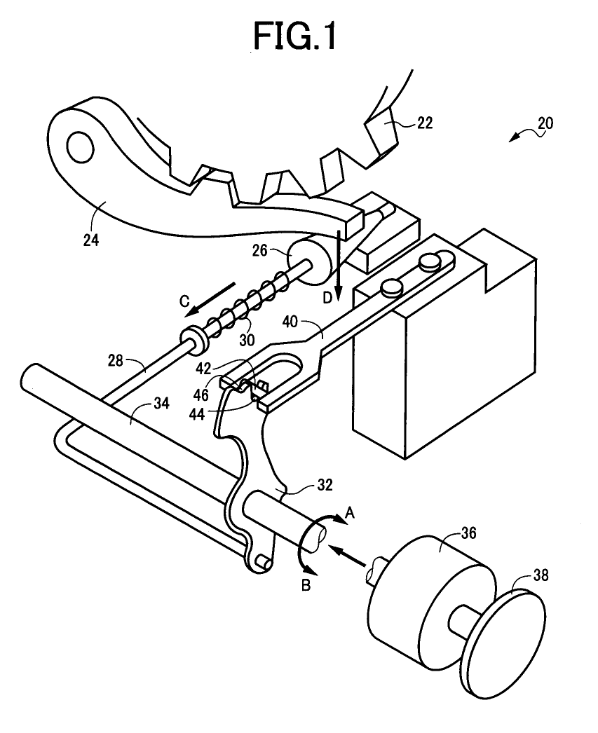

FIG. 1 is a view illustrating a structure of a parking lock mechanism 20 installed in a vehicle, to which the present invention is applied. The parking lock mechanism 20 includes: a parking gear 22 fixedly mounted on an output shaft operatively connected to drive wheels (not shown); a parking lock pawl 24 disposed movable to a meshing position in meshing engagement with the parking gear 22 to selectively lock the rotation of the parking gear 22; a parking rod 28 having one end inserted to a tapered member 26 held in abutting engagement with the parking lock pawl 24 to support the tapered member 26; a spring 30 carried on the parking rod 28 to urge the tapered member 26 in a direction toward a small diametric portion thereof.

The parking lock mechanism 20 further includes a detent plate 32 connected to the parking rod 28 at the other end thereof rotatably to be positioned in at least a parking position by means of a moderating mechanism; a shaft 34 fixedly mounted on the detent plate 32 and rotatable about one axis; an electric actuator 36 drivably rotating the shaft 34; a rotary encoder 38 detecting a rotational angle of the shaft 34; a detent spring 40 providing a moderating action onto the detent plate 32 during rotation thereof to fix the detent plate 32 in various shift positions; and an engaging portion 42 mounted on the detent spring 40 at a distal end thereof.

The detent plate 32 is operatively connected to a drive shaft of the electric actuator 36 via the shaft 34 and driven together with the parking rod 28 by the electric actuator 36 to function as a shift position determining member for switching shift positions of a transmission (not shown). The detent plate 32 has an apex portion formed with first and second concaved portions 44 and 46. The first concaved portion 44 is associated with a parking lock position and the second concaved portion 46 is associated with a non-parking lock position. In addition, the rotary encoder 38 outputs a pulse signal for acquiring a count value (encoder count) depending on a drive amount, i.e., a rotational amount, of the electric actuator 36.

FIG. 1 represents a situation under which the parking mechanism 20 is kept in a parking lock state, where the parking lock pawl 24 and the parking gear 22 are held in meshing engagement with each other such that the rotation of the parking gear 22 is blocked. Further, the parking gear 22 is operatively connected to the drive wheels (not shown), so that when the parking gear 22 is kept under a lock state the drive wheels are also similarly blocked in rotation. Position of the parking lock pawl 24 is adjusted by varying the abutment position with the tapered member 26 carried on the parking rod 28 at one end thereof When the parking lock pawl 24 is brought into abutment to for instance a large diameter portion of the tapered member 26, the parking gear 22 and the parking lock pawl 24 are brought into meshing engagement with each other to establish the parking lock state (see FIG. 1). In contrast, when the parking lock pawl 24 is brought into abutment to a small diameter portion of the tapered member 26, the parking lock pawl 24 disengages from the parking gear 22 to cancel the parking lock state.

The abutment position between the parking lock pawl 24 and the tapered member 26 is adjusted depending on an axial position of the tapered member 26. The axial position of the tapered member 26 is varied by the parking rod 28, so that the abutment position between the parking lock pawl 24 and the tapered member 26 is adjusted. If the tapered member 26 is moved in for instance a direction as indicated by an arrow C, then, the parking lock pawl 24 is brought into abutment to the small diameter portion of the tapered member 26. With a downward vertical movement of the distal end of the parking lock pawl 24, the meshing engagement between the parking lock pawl 24 and the parking gear 22 is cancelled. That is, the parking lock state is cancelled.

On the contrary, if the tapered portion 26 is moved in a direction opposite to the direction indicated by the arrow C, then, the distal end of the parking lock pawl 24 is brought into abutment to the large diameter portion of the tapered member 26. With an upward vertical movement of the distal end of the parking lock pawl 24, accordingly, the parking lock pawl 24 and the parking gear 22 are brought into meshing engagement with each other. That is, the parking lock state is established.

Further, an axial movement of the parking lock 28 is adjusted depending on a rotational position of the detent plate 32, i.e., a rotational position of the shaft 34. The electric actuator 36 rotates the shaft 34 to a rotational position controlled in response to an actuating signal of the electric actuator 36 output from an electronic control device configured to control the running range. Here, the shaft 34 has a rotational position, at which the first concaved portion 44 of the detent plate 32 and the engaging portion 42 carried on the detent spring 40 engage with each other, which is associated with the parking lock position, i.e., a position at which the parking gear 22 and the parking lock pawl 24 are held in meshing engagement with each other.

Meanwhile, the shaft 34 has another rotational position, at which the second concaved portion 46 of the detent plate 32 and the engaging portion 42 engage with each other, which is associated with the parking-lock canceling position, i.e., a position at which the parking gear 22 and the parking lock pawl 24 disengage from each other. As a parking lock command is output from the electronic control device, accordingly, the electric actuator 36 rotates the shaft 34 to the rotational position at which the first concaved portion 44 and the engaging portion 42 engage with each other. Further, as a parking-lock canceling command is output from the electronic control device, the electric actuator 36 rotates the shaft 34 to the rotational position at which the second concaved portion 46 and the engaging portion 42 engage with each other. Moreover, the rotational position of the shaft 34 is controlled such that the count value detected by the rotary encoder 38 by referring to a predetermined reference rotational position, becomes equal to count values corresponding to predetermined rotational positions associated with the parking lock position and the parking-lock canceling position.

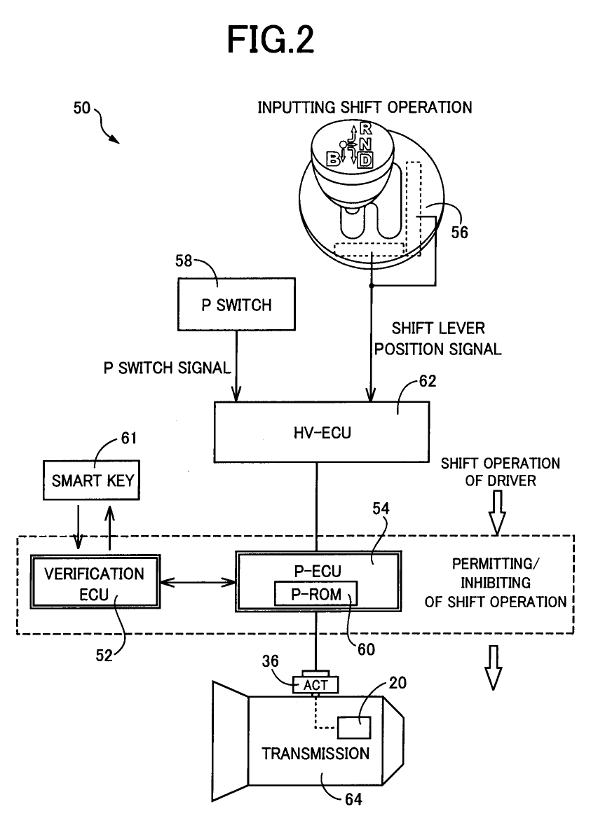

The parking mechanism 20 has a function not only to be actuated in response to a shift operation of the driver but also to serve as a part of an antitheft device 50 mounted on the vehicle. FIG. 2 is a view schematically illustrating a system of the antitheft device 50. Further, FIG. 2 represents a system diagram in the form of an exemplary case in which the antitheft device 50 is installed on a hybrid vehicle. A verification ECU 52 and a P-ECU 54 encircled by a broken line, correspond to the electronic control device for executing an antitheft control of the antitheft device 50. The P-ECU 54 executes a control in response to a command output from the verification ECU 52 for suitably performing the switching between: the parking lock canceling state (hereunder referred to as an lock canceling state) activating the parking-lock canceling operation under the parking lock state in response to the shift operation of a shift operation device 60; and the parking lock state (hereunder referred to as a lock state) disabling the parking-lock canceling operation under the parking lock state.

As the verification ECU 52 outputs a command to cause the antitheft device 50 to establish the lock canceling state, the rotational position of the shaft 34 (see FIG. 1) is switched from the parking lock position to the parking-lock canceling position in response to a shift operation of the shift operation device 56 for canceling the parking lock. On the contrary, as the verification ECU 52 outputs another command to cause the antitheft device 50 to establish the lock state, the rotational position of the shaft 34 (see FIG. 1) is caused to succeedingly remain under the parking lock position regardless of the shift operation of the shift operation device 56 for canceling the parking lock state. Moreover, as used herein, the term “lock canceling state” refers to a state under which even if the parking lock mechanism 20 remains in the parking lock state, the shift operation of the shift operation device 56 cancels the parking lock. In addition, the P-ECU 54 corresponds to an electronic control device that executes switching means of the present invention.

Hereunder, the operation of the antitheft device 50 under a normal state will be described. The P-ECU 54 operative to control the antitheft device 50 switches the lock state and the lock canceling state based on a stored value stored in the P-ROM 60 serving as the storage device incorporated in the P-ECU 54. Before the vehicle is started up (under a halt of the vehicle), the P-ROM 60 stores for instance a parking-lock state hold (hereunder referred to as the “lock state”) disabling (inhibiting) the shift operations of the shift operation device 56 and the P switch 58 to keep the lock state. Thus, the vehicle is kept under the lock state regardless of the shift operations. During the start-up of the vehicle, further, if verification is completed (in success) between a smart key 61 and the verification ECU 52, the verification ECU 52 outputs a lock-canceling command (request). In addition, as used herein, the term “completion in verification (success in verification)” corresponds to a case where when the verification ECU 52 receives a code delivered from the smart key 61 for verification with a code preliminarily stored therein, the respective codes match each other.

In accordance with such a routine, the lock state is switched to the lock canceling state in the antitheft device 50, thereby permitting the shift operation device 56 and the P switch 58 to perform the shift operations. Upon receipt of the parking lock canceling command delivered from the verification ECU 52 for permitting the shift operation device 56 to perform the shift operation and canceling the parking lock, the stored value of the P-ROM 60 is newly updated to the lock canceling state. Consequently, this enables the vehicle running. On the contrary, during a period in which the verification is not completed between the smart key 61 and the verification ECU 52, the shift operation is kept under an ineffective state based on the count value (lock state) of the P-ROM 60. That is, the P-ECU 54 executes the control based on the stored value stored in the P-ROM 60. Here, the P-ROM 60 corresponds to the store means of the present invention.

As used herein, the expression “verification between the smart key 61 and the verification ECU 52” refers to for instance operation for making verification (determination) as to whether an ID code output from the smart key 61 and received by the verification ECU 52 matches an ID code stored in the verification ECU 52. If verification is matched, then, the verification ECU 52 outputs the lock-canceling command to the P-ECU 54, upon which the lock state is cancelled. With the shift operation permitted during running of the vehicle, further, the shift operation device 56 outputs a shift switching signal, which in turn is delivered through an HV-ECU 62 for hybrid control to the P-ECU 54, so that the rotational position of the electric actuator 36 is controlled. Thus, the running range can be suitably switched in the transmission of the hybrid vehicle. Furthermore, the verification on the ID codes of the verification ECU 52 and the smart key 61 may be carried out after the verification between the smart key 61 and the verification ECU 52.

When the vehicle power supply is cut off with the vehicle being halted, further, the driver executes a turn-off operation (ignition turn-off operation) for cutting off the power supply. In accordance with such ignition turn-off operation, the verification ECU 52 outputs the parking lock command for activating an antitheft function, upon which the shaft 34 is switched to the parking lock position. In this moment, the stored value of the P-ROM 60 is updated to the lock state under which the shift operations of the shift operation device 56 and the P switch 58 are disabled (inhibited) to maintain the lock state. In addition, the P-ROM 60 serving as the store means is comprised of non-volatile memories, such as for instance MRAM, EEPROM, EPROM AND NVRAM, etc., in which stored contents (stored values) are saved even when the power supply is cut off. Therefore, the stored values can be saved even when the vehicle remains halted to disable a fraudulent shift operation, thereby causing the antitheft device 50 to effectively function.

As set forth above, the lock request state and lock-cancel request state output from the verification ECU 52 are stored in the P-ROM 60 of the P-ECU 54 and suitably updated to new stored values. In this case, the stored values of the P-ROM 60 are updated in priority to, i.e. preceding to the shift operations of the shift operation device 56 and the P switch 58. If the stored value of the P-ROM 60 belongs to for instance the lock canceling state to maintain the lock canceling state enabling the shift operation (parking lock canceling operation), the shift operations are enabled involving the parking lock canceling operation executed by the shift operations device 56 and the P switch 58. Meanwhile, if the stored value of the P-ROM 60 belongs to for instance the lock state to maintain the lock state disabling the shift operation, the shift operation for canceling the parking lock state is disabled.

During the initial start-up of the vehicle carried out on assembly of the vehicle, the verification and registration work is carried out on a production line. If the verification and registration work are not completed, none of the lock command or the lock-cancel command is output from the verification ECU 52. If a failure occurs in the verification and registration work, then, the shift operation remains enabled or disabled depending on the stored value stored in the P-ROM 60 at first. Conventionally, the stored value of the P-ROM 60 has been set to the lock state before shipment to disable the shift operation. Accordingly, if the verification and registration work is failed, the relevant vehicle is pushed out of the production line once to a rework area, where the verification and registration work is carried out again. In this case, since the shift operation of the vehicle is disabled (inhibited), the parking mechanism 20 sustained under the parking lock position can not be cancelled. Thus, the vehicle can not be pushed out with hand work or the like. There has been a problem that much time is required for the vehicle to be pushed out, which leads to stop of the production line.

In view of this, with the present embodiment, setting an initial stored value of the P-ROM 60 to the lock canceling state activating the shift operation (parking lock canceling operation) allows the parking lock canceling operation to be executed even if the failure occurs in the verification and registration work carried out on the production line. This makes it possible to immediately push the relevant vehicle out of the production line by hand work or the like. In addition, the initial stored value of the P-ROM 60 is input for instance at a manufacturing factory of the P-ECU 54 in advance. That is, the lock canceling state is input to the P-ROM 60 for storing to activate the parking lock canceling operation (shift operation) on production of the P-ECU 54. Hereunder, an advantageous effect of setting the initial stored value to the P-ROM 60 as described above, will be described in further detail.

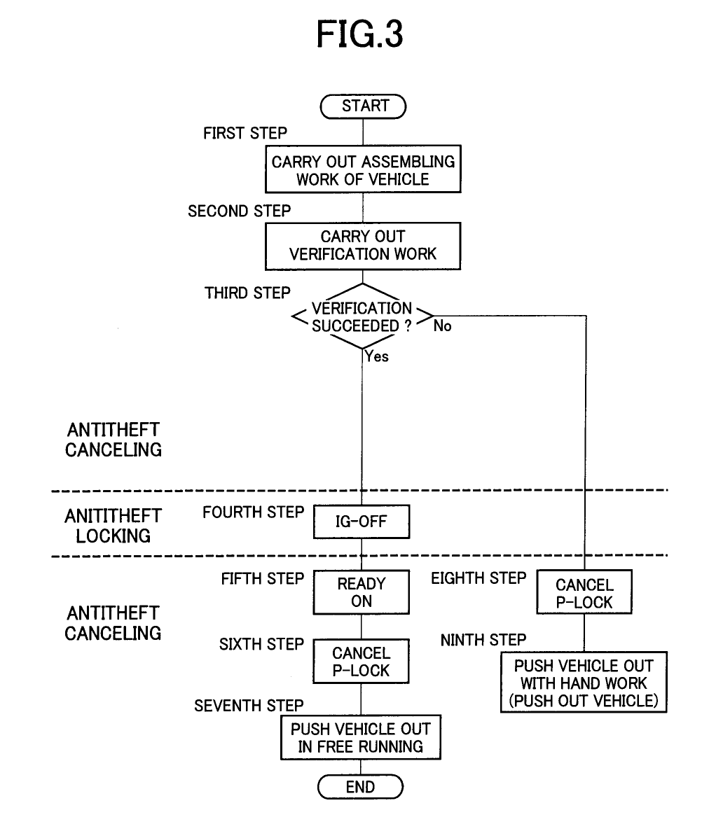

FIG. 3 is a work view illustrating a process of a vehicle production line to which the present embodiment is applied. In FIG. 3, it is supposed that the initial stored value of the P-ROM 60 belongs to the lock canceling state for activating the shift operation, i.e., the parking lock canceling operation before shipment of the P-ECU 54. Initially, at a first step, assembling work of the vehicle is carried out on the production line. After the assembling work of the vehicle is completed, then, the verification and registration work is carried out at a second step. Here, an electric power is supplied to an electronic equipment such as the electronic control device (ECU) or the like for the first time to start up various electronic equipments. It is designed such that upon start-up of the electronic equipment, the HV-ECU 62 outputs a command to the parking mechanism 20 for switching the same to the parking lock position in priority to the P-ECU 54. This allows the verification and registration work to begin with the parking mechanism 20 remained under the parking lock state.

As used herein, the term “verification and registration work” refers to the initial registration work to be carried out for making verification between a key associated with the relevant vehicle and the verification ECU 52. More particularly, under a condition where a mode of the vehicle is allocated to a verification registration mode in response to an output delivered from an external terminal, holding the smart key 61 over a key slot of the vehicle for a predetermined time period allows the verification and registration to be electrically executed between a code of the smart key 61 and a code of the verification ECU 52. As the verification and registration work is completed, an ignition turn-off operation is executed at a fourth step for cutting off the vehicle power supply once (in IG-OFF).

When the power supply is cut off, the verification ECU 52 outputs the lock state command for switching the parking mechanism 20 to the lock state, and to disable the shift operation. This updates the stored value of the P-ROM 60 from the lock canceling state to the lock state (antitheft locking). Subsequently, at a fifth step, the smart key 61 is subjected to a verification, thereby turning on the vehicle power supply again (in READY-ON). In this moment, the verification ECU 52 outputs a lock-canceling command enabling the shift operation (parking lock canceling operation) to be performed, causing the stored value of the P-ROM 60 to be updated to the lock canceling state. Thus the shift operation (parking lock canceling operation) is made effective. Then, at a sixth step, the shift operation device 56 switches the parking lock mechanism 20 from the lock state to the lock canceling state (P-lock cancellation). At a seventh step, further, the vehicle is pushed out to a predetermined area for instance in free running.

In contrast, if the verification and registration work carried out at a third step is completed in failure, the routine proceeds to a eighth step. The failure in the verification and registration work may be derived for reasons described below. For instance, if a spare key separately prepared from the smart key 61 is placed near the smart key 61 during the verification and registration work, crosstalk occurs to hinder or to block completion of the verification and registration work. Further, in carrying out the verification and registration work, if the mode switching operation to the verification registration mode carried out using an external terminal is omitted, the verification and registration work can not be completed. Under such a situation, furthermore, if a predetermined operating time elapses on the production line, then, the verification and registration work results in the failure.

If the failure occurs in the verification and registration work, the relevant vehicle is taken out of the production line once for carrying out the verification and registration work again on handled adjustment work prepared in a separate area. In order to take the relevant vehicle out of the production line, at a eighth step, the shift operation is executed to switch the parking mechanism 20 from the lock state to the lock canceling state. Here, since the stored value of the P-ROM 60 is preliminarily set to the lock canceling state before shipping from the factory, even if the failure occurs in the verification and registration work, the shift operation is made effective, enabling a shift range to be switched to for instance a neutral range (N range) (P-lock cancellation). At a ninth step, the vehicle is immediately taken out of the production line with for instance hand work or the like. With such operations discussed above, even if the failure occurs in the verification and registration work, the vehicle can be immediately taken out of the production line, thereby preventing the production line from being stopped.

Meanwhile, when the P-ECU 54 and the verification ECU 52 are assembled to the vehicle on the production line thereof, the P-ROM 60 is assembled to the vehicle with setting the initial stored value to the lock canceling state. This enables the vehicle to be immediately taken out when the failure occurs in the verification and registration work. However, for the other production line than the production lines of for instance an auto-repair garage or a dealer shop, the P-ROM 60 is supplied with setting the initial stored value to the lock state. Upon assembling in an area apart from the production line, if the P-ROM 60 is assembled to the vehicle with setting the initial stored value to the lock canceling state, the shift operation (parking lock canceling operation) is made effective even when the failure occurs in the verification and registration work, thereby enabling the vehicle to move. Accordingly, the antitheft device 50 does not exhibit its function, resulting in a steal of the vehicle. On the contrary, in a case where the P-ECU 54 is supplied as supplies to the repair shop or the like, the initial stored value of the P-ROM 60 set to the lock state is determined, then, the shift operation is made ineffective unless the verification is completed due to ineffectiveness of the shifting operation. This allows the antitheft device 50 to effectively function, thereby preferably preventing the steal of vehicle.

According to the present embodiment, the initial value of the P-ROM 60 (store means) is set to the parking-lock canceling state which makes the parking lock cancelling state effective. Thus, even if a failure occurs in the verification and registration work carried out during assembly, the parking lock can be cancelled. Accordingly, canceling the parking lock can immediately push the vehicle out of the production line by hand work or the like. Associating with such an effect, a stop of the production line for push-out of the vehicle can be prevented.

According to the present embodiment, the initial value of the P-ROM 60 (store means) is set to the parking-lock canceling state for assembly on a production line and is set to the parking lock state for assembly on other area than the production line. Accordingly, establishing the parking lock state in other area than the production line can prevent a drop in an antitheft performance when assembling the vehicle in the other area than the production line.

According to the present embodiment, the P-ROM 60 (store means) is comprised of non-volatile memories that hold an information even if a power supply is cut off or interrupted. With such a structure, even if the power supply is cut off, the information can be held in the P-ROM 60, i.e., the P-ROM 60 causes the antitheft device to function effectively during a halt, i.e., stop of a vehicle. That is, if the P-ROM 60 is set to a parking lock state when the vehicle power supply is cut off, a parking-lock canceling operation is disabled for the halt of the vehicle, so that theft of the vehicle is prevented.

Further, according to the present embodiment, the P-ROM 60 (store means) may be updated to a parking-lock canceling state to activate a parking-lock canceling operation upon start-up of the vehicle. When the vehicle power supply is turned off, the P-ROM 60 is sequentially updated to a parking lock state to disable the parking-lock canceling operation. With such updating, the parking-lock canceling operation is activated for start-up of the vehicle, thereby making it possible to run the vehicle. Meanwhile, when the vehicle is halted with the vehicle power supply being turned off, the parking-lock canceling operation is disabled to prevent theft of the vehicle during the halt thereof.

Furthermore, according to the present embodiment, the store information stored in the P-ROM 60 may precedes a shift command in response to a shift operation of a driver. With such priority, the parking lock state is sustained regardless of or independent of the shift operation of the driver, thereby preventing theft of the vehicle during the halt thereof. During running of the vehicle, moreover, the parking-lock canceling state is established, so that the shift operation of the driver is permitted to enable the vehicle to run.

In the foregoing, although the present invention has been described with reference to the embodiment shown in the drawings, the present invention may also be implemented in other modes.

In the illustrated embodiment, although description has been provided of the hybrid type vehicle as an example, the present invention may have application even to a vehicle equipped with for instance the conventional step-variable type automatic transmission or continuously variable automatic transmission. In brief, the present invention may be applied to a vehicle which includes a shift-by-wire type shift mechanism having the parking mechanism 20.

In the illustrated embodiment, further, the parking mechanism 20 represents one example, and the parking mechanism configured in another structure may employed. That is, the present invention may be freely applied to the vehicle which has a structure available to be mechanically locked.

In the illustrated embodiment, furthermore, although the verification ECU 52 and the P-ECU 54 are formed in separate structures composed of the respective electronic control devices, these components have no need to be necessarily formed in the separate structures, and these components may be formed in one electronic control device.

In the illustrated embodiment, moreover, although the P switch 58 has been comprised of the switch configured to output the parking lock command causing the parking mechanism 20 to establish the parking lock state, the P switch 58 may have another function combined with the above function to output the parking lock canceling command causing the parking mechanism 20 to establish the parking-lock canceling state.

In the illustrated embodiment, besides, although the fourth step (IG-OFF) has been executed between the third and fifth steps, the fourth step may be carried out after the seventh step.

It is intended that the present invention described be considered only as illustrative of one embodiment and that the present invention may be implemented in various modifications and improvements based on knowledge of those skilled in the art.

1. An antitheft device for vehicle comprising store means storing a parking-lock canceling state activating a parking lock canceling operation and a parking lock state disabling the parking lock canceling operation alternatively, and switching means switching the parking lock state to the parking-lock canceling state upon success of a verification, wherein:
an initial value of the store means is set to the parking-lock canceling state.

2. The antitheft device for vehicle according to claim 1, wherein the initial value of the store means is set to the parking-lock canceling state for assembly on a production line and is set to the parking lock state for assembly on other area than the production line.
